(19) United States
(12) Patent Application Publication
(10) Pub. No.: US 2007/0091858 A1
(43) Pub. Date: Apr. 26, 2007

(54) Method and apparatus for tracking unauthorized nodes within a network

(76) Inventors: Xiaohua Wu, Kildeer, IL (US); Thomas S. Babin, Lake Zurich, IL (US); Guoshu Song, Schaumburg, IL (US); Joseph P. Tomase, Libertyville, IL (US); Yinyan Wang, Palatine, IL (US); Chuntao Zhang, Buffalo Grove, IL (US)

Correspondence Address: MOTOROLA, INC., 1303 EAST ALGONQUIN ROAD, IL01/3RD, SCHAUMBURG, IL, 60196, US

(21) Appl. No.: 11/257,602

(22) Filed: Oct. 24, 2005

(51) Int. Cl. H04Q 7/24

(52) U.S. Cl. 370/338

(57) ABSTRACT

A network (100) will receive requests from unauthorized nodes that wish to join/access the network. While access may be denied for the unauthorized nodes, the network will continue to monitor these nodes for location information. The unauthorized nodes will be located, and their location will be monitored.

### FIELD OF THE INVENTION

The present invention relates generally to locating nodes within a network, and in particular to a method and apparatus for tracking unauthorized nodes within such networks.

### BACKGROUND OF THE INVENTION

As more and more network devices access networks via wireless transmission/reception, the chance that unauthorized users will attempt to gain access to any secure network only increases. Because of this, future networks will be dealing with many unauthorized access requests daily. It should be noted that not all unauthorized access requests are due to unauthorized users trying to gain access to the system. For example, a node using a BLUETOOTH network protocol may try to automatically register with any BLUETOOTH device that the node senses. It would be beneficial to monitor these unauthorized nodes in order to determine parameters that might be requested, or be used at a later time.

### BRIEF DESCRIPTION OF THE DRAWINGS

FIG. 1 is a block diagram of a wireless network.

FIG. 2 is a block diagram of a wireless node from FIG. 1.

FIG. 3 is a block diagram of a processing node of FIG. 1.

FIG. 4 is a flow chart showing operation of a node granting or denying access to the network of FIG. 1.

### DETAILED DESCRIPTION OF THE DRAWINGS

To address the above-mentioned need a method and apparatus for tracking unauthorized nodes within a network is provided herein. During operation the network will receive requests from unauthorized nodes that wish to join/access the network. While access may be denied for the unauthorized nodes, the network will continue to monitor these nodes for location information. The unauthorized nodes will be located, and their location will be monitored.

The present invention encompasses a method for tracking an unauthorized user within a network. The method comprises the steps of communicating with a plurality of authorized wireless devices, receiving communication from a wireless device requesting access to the network, and determining location parameters for the wireless device. A determination is made that the wireless device is an unauthorized device and access is denied to the network for the wireless device while monitoring location parameters for the wireless device.

The present invention encompasses an apparatus comprising a transceiver communicating with a plurality of authorized wireless devices and receiving communication from a wireless device requesting access to a network. Logic circuitry is provided for determining location parameters for the wireless device, determining that the wireless device is an unauthorized node, and denying access to the network for the wireless device while monitoring location parameters for the wireless device.

The present invention encompasses a method for tracking an unauthorized user within a network. The method comprises the steps of communicating with a plurality of authorized wireless devices in an ad-hoc network, receiving communication from a wireless device requesting access to the network, and determining location parameters for the wireless device. A determination is made that the wireless device is an unauthorized wireless device and access is denied to the network for the wireless device while monitoring location parameters for the wireless device. Finally, the wireless devices location parameters are reported to a network security controller.

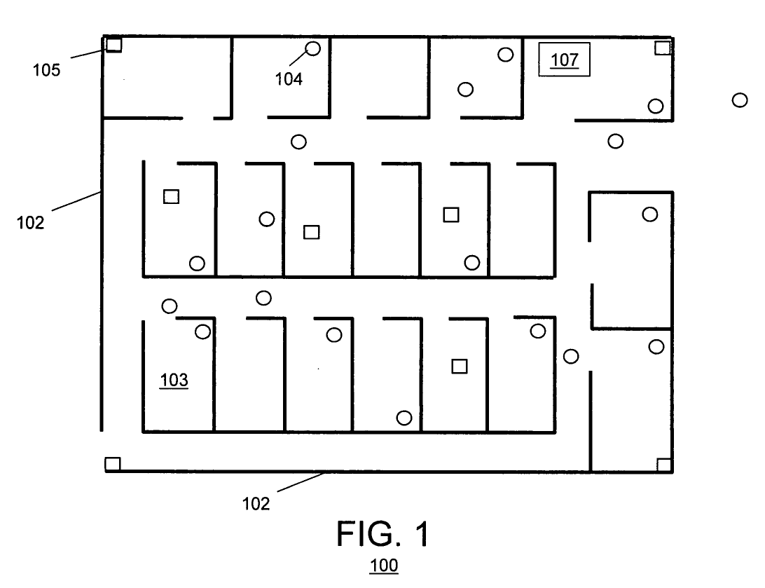

Turning now to the drawings, wherein like numerals designate like components, FIG. 1 is a block diagram of wireless network 100. In a preferred embodiment of the present invention network 100 comprises an ad-hoc network such as a neuRFon™ network available from Motorola, Inc. that utilizes the neuRFon™ network protocol. Other possible forms for network 100 include, but are not limited to, networks utilizing the ZigBee™, IEEE 802.11™, HiperLAN™, or HiperLAN/2™ protocols.

As shown, wireless network 100 is superimposed on a floor plan of an interior of an office building, with perimeter wall 102 enclosing a plurality of offices 103 (only one office labeled). Although shown in a two-dimensional setting one of ordinary skill in the art will recognize that wireless network 100 may exist in any physical two or three-dimensional location. Wireless network 100 includes a number of wireless nodes 104, 105, and 107 involved in determining node location in a centralized manner.

Circular objects 104 (only one labeled) represent wireless devices, nodes, remote, or mobile units, the locations of which may vary and are not known prior to the performance of a location-determining process. Such devices include, but are not limited to, lap top computers, wireless communication devices including cellular telephones, wireless sensors, etc. Wireless nodes 104 can be associated with network 100 (not authenticated) in that the network will accept certain command messages related to an authentication routine. Wireless nodes 104 can also be authenticated in that they have been allowed access to network 100 and are allowed to transmit and receive data messages.

Rectangular objects 105 (only one labeled) represent reference nodes similar to wireless nodes 104 except that the locations of reference nodes 105 are known prior to the performance of any location-determining process. Further, reference nodes 105 may be dedicated location-determining nodes that transmit location data, but do not receive. Wireless nodes 104 and reference nodes 105 are utilized in determining the locations of any candidate node 104 wishing to gain access to network 100. In a preferred embodiment of the present invention processing node 107 is provided, comprising location-finding equipment (LFE) to perform calculations involved in determining the location of any candidate node in a centralized manner as will be described below in more detail.

As described above, as more and more network devices access networks via wireless transmission/reception, the chance that unauthorized users will attempt to gain access to any secure network only increases. Because it would be beneficial to track locations of all users (authorized an unauthorized), the locations of nodes attempting to access network 100 are determined for all nodes attempting to access network 100. Because the location of unauthorized users is maintained, security can be notified of the attempted access and the location of the node can be provided.

With the location information of unauthorized nodes, the administrator of network 100 can monitor the activity of the unauthorized node, identifying the unauthorized nodes location to a room or a floor. Additionally, the administrator of network 100 can shut down the unauthorized access from the whole coverage area of network 100 or from a physical vicinity of the network 100 to prevent the unauthorized nodes from interfering with the operation of network 100.

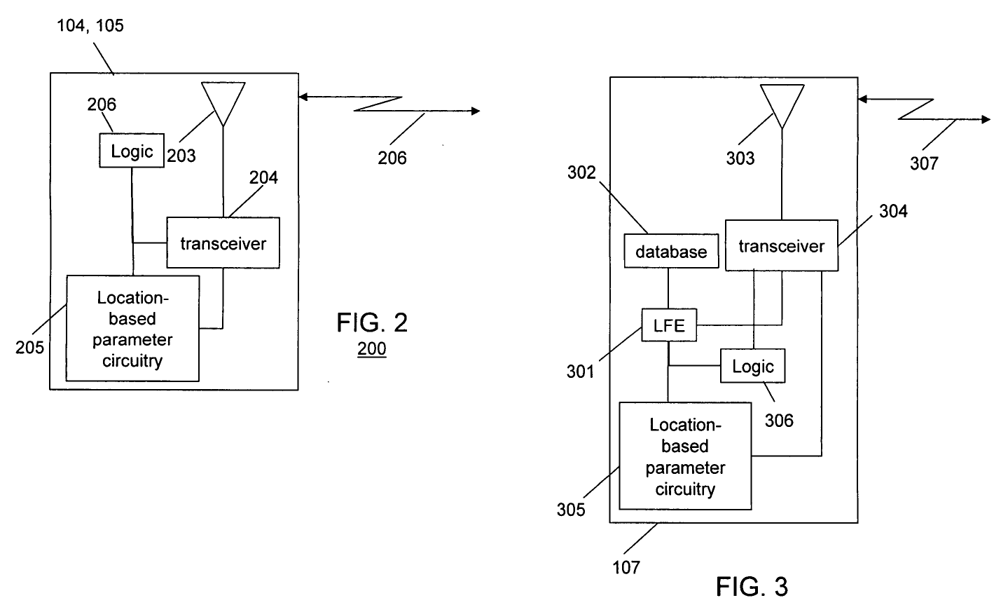

FIG. 2 is a block diagram of a wireless node 200 which may act as node 104 or reference node 105. When performing the functions of a standard node 104, node 200 determines the value of at least one location-based parameter of the signals received from other wireless nodes 104, reference nodes 105, or processing nodes 107, and provides data related to this parameter to processing node 107 for location determination in a centralized manner. A “location-based parameter” is any property of a received signal that may be used to infer the location of one or more nodes in network 100.

As shown wireless node 200 is equipped with antenna 203 transmitter/receiver (transceiver) 204, and location-based parameter circuitry 205. When wireless node 200 wishes to determine a node's location, it receives over-the-air communication signal 206 transmitted from the node to be located. In a preferred embodiment, signal 206 comprises a nonce that uniquely identifies signal 206; the nonce may comprise a time stamp that identifies the time at which signal 206 was sent. Once received by transceiver 204, the processed signal 206 (and the nonce, if present) is passed to location-based parameter circuitry 205.

If location-based parameter circuitry 205 is utilizing a signal-strength technique to determine location information, location-based parameter circuitry 205 determines a signal strength value and passes a value related to this signal strength to processing node 107 via transceiver 204. In a similar manner, if location-based parameter circuitry 205 is utilizing a time-of-arrival technique to determine location information, location-based parameter circuitry 205 determines a time-of-arrival value and passes a value related to this time-of-arrival value to processing node 107. Finally, if location-based parameter circuitry 205 is utilizing an angle-of-arrival technique to determine location information, location-based parameter circuitry 205 determines an angle-of-arrival value and passes a value related to this angle-of-arrival value to processing node 107. One of ordinary skill in the art will recognize that other techniques to determine location information, including but not limited to the use of the described techniques in combination, are also possible and fall within the scope of the present invention.

As discussed above, node 200 may additionally act as a reference node. As discussed, the locations of reference nodes 105 are known prior to the performance of any location-determining process. Further, reference nodes 105 may be dedicated location-determining nodes that transmit location data, but do not receive. Thus transceiver 204 may not receive, operating as a transmitter only. When acting as a reference node, transceiver 204 transmits signal 206 from time to time, providing location information to at least one other node in network 100. This location information preferably comprises the node's location, which can be used to calibrate any node aiding in location.

In an alternative embodiment, transceiver 204 operates as both a transmitter and receiver, with node 200 responding to received requests from at least one other node in network 100 to transmit location information. In yet another embodiment, transceiver 204 operates as both a transmitter and receiver, and optional location-based parameter circuitry 205 is coupled to transceiver 204. In this embodiment, node 200 provides location information and communication services in a manner similar to that of a wireless node, the difference being that the location of reference node 105 is known prior to the performance of a location-determining process.

FIG. 3 is a block diagram of processing node 107. Processing node 107 serves to locate any node wishing to access network 100. As shown, processing node 107 is equipped with antenna 303 location-finding equipment (LFE) 301, database 302, logic circuitry 306, and location-based parameter circuitry 305. Although shown coexisting within node 107, LFE 301 and database 302 may also be physically remote from node 107 and, for example, connected via a local-area network or the Internet.

As discussed above, processing node 107 may be solely utilized for location estimation and granting access to network 100 in a centralized manner. In an alternative embodiment, many processing nodes 107 may be placed in network 100, operating as wireless nodes 104 except that processing nodes 107 are also equipped at least to perform a location-determining function and grant network access in a distributed manner. During operation, transceiver 304 receives communication signal(s) 307 via antenna 303, from at least one of nodes 104, 105, and 107. Location-based parameter circuitry 305 analyzes the signal(s) 307 and generates location-based parameters contained within the signal(s). This information is then passed to LFE 301, which stores it in database 302. LFE 301 then utilizes the information in database 302 to determine the location of one or more wireless nodes, either in network 100 (wireless nodes 104, reference nodes 105, and other processing nodes 107) or candidate nodes attempting to access network 100. While the exact method for locating a node is immaterial to this discussion, in a preferred embodiment of the present invention a signal strength technique is utilized as described in U.S. Pat. No. 6,473,078, “Method and Apparatus for Location Estimation,” by Patwari, et al.

Network 100, equipped as described above, will have the resources necessary to allow and deny network access based on various criteria. Although various access techniques may be utilized, in a preferred embodiment of the present invention, a modified version of the access technique described in ZigBee Alliance Document 03322r12, “Security Services Specification”, is utilized. As described in the ZigBee document, a device may request access to network 100 by issuing a network discovery request (NLME-NETWORK-DISCOVERY), which results in the transmission of a beacon request command. When a member of network 100 hears the request, it will transmit a beacon to the candidate node requesting access. The beacon will identify network 100, along with its security level and frame attributes. In reply, the candidate node transmits an association request command. Other devices in network 100, such as wireless nodes 104, reference nodes 105, and processing nodes 107, that are within range of the candidate node also receive the association request command, and determine the location parameter of the candidate node (as discussed above). When location is determined in a centralized manner, devices that overheard the association request command sent by the candidate node, forward at least a value related to the received signal strength to processing node 107, along with the address of the device to which the association request command was sent. Processing node 107 then estimates the location of the candidate device, by performing a location-estimation algorithm in LFE 301.

Once located, the candidate node is either granted or denied access to the network. This decision may be made by logic circuitry 306 of processing node 107, the node to which the association request command was made, or one or more other nodes in the network. Regardless of where the decision was made, the decision is sent to the node to which the association request command was made. If access is given to the candidate node, the candidate node is sent an affirmative association response command in reply to its association request command. The candidate node is then considered to be associated (joined) to network 100, but not yet authenticated. The authentication procedure only proceeds for those candidate nodes allowed network access.

ZigBee has allows for several different authentication procedures. In the preferred embodiment of the present invention the procedure invoked when the candidate node 104 has a preconfigured network key is employed. More particularly, after a candidate node receives the affirmative association response command, it receives a transport-key command, transporting a dummy network key containing all zeros. At this point it is authenticated, and may now function as a member of network 100 using the network key stored in it at some earlier time.

If the candidate node is denied access to the network, it is informed in a negative association response command, sent in reply to its association request command. The candidate node then cannot begin an authentication procedure, and cannot function as a member of network 100. Note that a candidate can be refused network access even if it has a preconfigured network key and therefore is cryptographically capable of operating in network 100. This is useful, for example, to reduce the potential for abuse of mass-produced items that, to reduce manufacturing cost and increase usability by inexperienced users, are produced with the same preconfigured network key. Network 100 may periodically update the location for the candidate node by having node 107 periodically send out a request to nodes within network 100 to locate the candidate node.

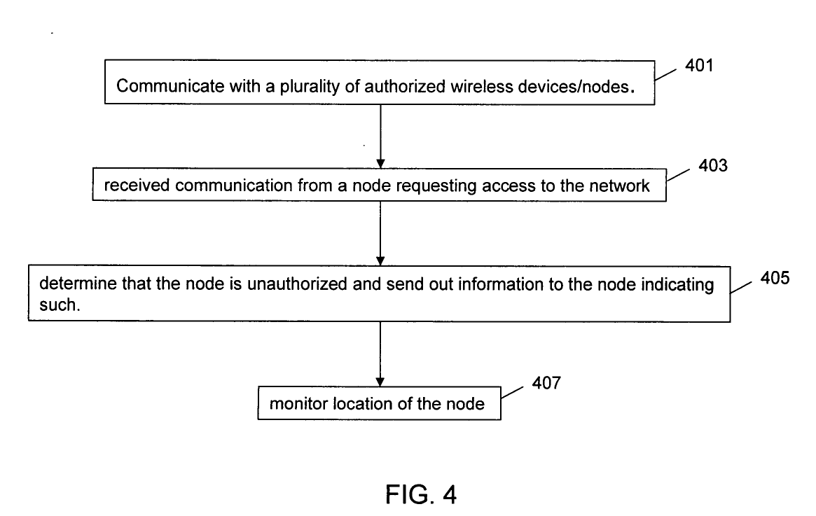

FIG. 4 is a flow chart showing operation of a node granting or denying access to the network of FIG. 1. As discussed above, the decision to allow or deny access to the network may be made by logic circuitry 306 of processing node 107, the node to which the association request command was made, or one or more other nodes in the network. Regardless of where the decision is made, once a node is denied access, location parameters for the node will be monitored.

The logic flow begins at step 401 where communication is taking place with a plurality of authorized wireless devices (e.g., ad-hoc nodes). Communication between the wireless devices simply comprises standard network communication using transceivers 204/304. At step 403, a communication is received by the transceiver from a node requesting access to the network. At step 405, logic circuitry 206/306 determines that the node is unauthorized and sends out information to the node indicating whether or not the node was allowed to access the network. Finally, at step 407, logic circuitry 206/306 continues to monitor location of the node requesting access. As discussed above, logic circuitry 206/306 may have denied access to the network for the node but will continue monitoring location parameters for the node. Additionally, logic circuitry 206/306 may instruct transceivers 204/304 to periodically report the wireless device's location parameters to a network security controller.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for tracking an unauthorized user within a network, the method comprising the steps of:
communicating with a plurality of authorized wireless devices;
receiving communication from a wireless device requesting access to the network;
determining location parameters for the wireless device;
determining that the wireless device is an unauthorized wireless device; and
denying access to the network for the wireless device while monitoring location parameters for the wireless device.

2. The method of claim 1 further comprising the step of:
reporting the wireless device's location parameters to a network security controller.

3. The method of claim 2 wherein the step of communicating with the plurality of authorized wireless devices comprises the step of communicating with a plurality of wireless ad-hoc network nodes.

4. The method of claim 1 wherein the step of communicating with the plurality of authorized wireless devices comprises the step of communicating with a plurality of wireless ad-hoc network nodes.

5. An apparatus comprising:
a transceiver communicating with a plurality of authorized wireless devices and receiving communication from a wireless device requesting access to a network;
logic circuitry determining location parameters for the wireless device, determining that the wireless device is an unauthorized wireless device, and denying access to the network for the wireless device while monitoring location parameters for the wireless device.

6. The apparatus of claim 5 wherein the logic circuitry instructs the transceiver to periodically report the wireless device's location parameters to a network security controller.

7. The apparatus of claim 6 wherein the wireless devices comprise ad-hoc network nodes.

8. The apparatus of claim 5 wherein the wireless devices comprise ad-hoc network nodes.

9. A method for tracking an unauthorized user within a network, the method comprising the steps of:
communicating with a plurality of authorized wireless devices in an ad-hoc network;
receiving communication from a wireless device requesting access to the network;
determining location parameters for the wireless device;
determining that the wireless device is an unauthorized node; and
denying access to the network for the wireless device while monitoring location parameters for the wireless device; and
reporting the wireless devices location parameters to a network security controller.
